(19) United States
(12) Patent Application Publication
(10) Pub. No.: US 2022/0278414 A1
(43) Pub. Date: Sep. 1, 2022

(54) ENERGY STORAGE SYSTEM AND METHOD FOR PRODUCING AN ENERGY STORAGE SYSTEM

(71) Applicant: Lisa Dräxlmaier GmbH, Vilsbiburg (DE)

(72) Inventors: Michael RÖMELSBERGER, Niedertaufkirchen (DE); Robert Magunla, Geisenhausen (DE)

(21) Appl. No.: 17/637,490

(22) PCT Filed: Aug. 24, 2020
(86) PCT No.: PCT/EP2020/073637

§ 371 Date: Feb. 23, 2022

(30) Foreign Application Priority Data
Aug. 26, 2019 (DE) 10 2019 122 804.2

(51) Int. Cl. H01M 50/284; H01M 50/507; H01M 50/296; H01M 50/249; H01M 10/42; B60L 53/16

(52) U.S. Cl. CPC H01M 50/284; H01M 50/507; H01M 50/296; H01M 50/249; H01M 10/425; B60L 53/16; H01M 2220/20; H01M 2010/4271

(57) ABSTRACT

The present disclosure relates to a multifunction carrier for accommodating circuit components of a battery system for an electric vehicle, the multifunction carrier including: a bus bar assembly having at least a charging terminal bar and a drive terminal bar; and an insulating housing in which the power rail assembly is embedded, wherein the insulating housing has openings exposing contact surfaces of the terminal rails, and wherein the insulating housing has connectors configured to make pluggable mechanical and electrical contact between the circuit components of the battery system and the opened contact surfaces of the terminal rails. The present disclosure further relates to a high voltage contactor for a battery system of an electric vehicle.

### CROSS REFERENCE TO RELATED APPLICATIONS

This application is a national phase of international patent application PCT/EP2020/073637, filed 24 Aug. 2020 and which claims priority to German patent application DE 102019122804.2, the content of both of which is herein incorporated by reference.

### BACKGROUND OF THE INVENTION

### Field of the invention

The present invention relates to a multifunction carrier for accommodating circuit components of a battery system for an electric vehicle and to a high-voltage contactor for a battery system of an electric vehicle, in particular to a high-voltage contactor which can be plugged into the multifunction carrier fully automatically.

### Description of the Related Art

The assembly of circuit components of the battery system of an electric vehicle (electrified or battery-electric) today involves considerable effort and cannot be done fully automatically. Thus, a separate component carrier is required to hold the electrical components and to accommodate the insulating parts. This requires complex routing of cable harnesses. When integrating a cable spider, an additional part is required. After the assembly, a manual inspection by workers must be carried out with regard to counter-tension testing. This is associated with a complex assembly concept with many work steps and auxiliary templates. Furthermore, a separate thermal connection with GapPads or Gapfillers including protective foils is required.

Currently, high-voltage contactors are used in battery systems for electrified or battery-electric vehicles to connect, disconnect and protect the electrical loads. To enable the control electronics or the battery management unit to measure the voltage in the DC link and thus detect the current switching state, voltage taps are used in addition to the HV contactors. These are implemented as screwed ring cable lugs or insert plates for flat plug connections, which leads to additional assembly effort due to susceptible screw processes or also additional HV cable set.

The assembly of circuit components described above is associated with numerous disadvantages. There are long assembly times, with many work steps being required, which is associated with the risk of incorrect assembly of components, particularly in the case of HV-critical components. Furthermore, there are undesirable clearance and creepage distances, and the thermal connection is not particularly good. In addition, there are large assembly tolerances in the manufacture of the components.

### BRIEF SUMMARY OF THE INVENTION

It is an object of the present invention to provide a concept for fully automated manufacturing of the circuit components of the battery system of an electric vehicle, which overcomes the disadvantages described above.

Furthermore, it is an object of the invention to provide a concept for a simpler provision of the high voltage (HV) potentials at the HV contactor, so that the assembly of the HV contactor is simplified.

This and other such tasks are addressed by the objects of the present invention Advantageous embodiments are also set out, at least in the description and the drawings.

The present invention is directed to a multi-functional carrier or assembly of a multi-functional carrier which can accommodate HV busbars (busbar interconnection—also control and HV taps), PCB connectors, wiring harness and electrical components. This can be fed fully automatically, can be welded at HV interfaces and allows machine inspection of secondary interlocks. Air and creepage distances can also be considered here due to the insulation with smaller dimensions. With a thermally conductive plastic or the use of gap pads or gap fillers, hot spots in the system can also be connected, e.g., to a cooling system.

With this solution, all electrical components can be integrated in one component. Integration of the wiring harness in this component is possible without an additional carrier. This eliminates manual assembly steps, which leads to a higher degree of automation; in particular, full automation of the assembly work steps is possible. Furthermore, many standard parts, such as screws and nuts, are omitted, so that a safeguarding of screw waste is also not necessary.

The invention is further based on the idea of providing an HV contactor in which the HV potentials of the two HV terminals can be tapped by a plug-in system or flat plug tongues integrated on the contactor. This eliminates the need for additionally attached ring cable lugs or spade terminals.

This allows fully automated production of HV contactors or HV switch boxes, which leads to significant cost savings in the production of the boxes.

Such an HV contactor is more cost-effective in production, since time-consuming screwing processes are no longer required, and instead only plugging is necessary. The switching state of each contactor, e.g., main contactors, DC charging contactors, etc. can always be reliably detected. Furthermore, the absence of voltage in the system can be efficiently determined, as previously with the ring cable lugs in the HV wiring harness.

In accordance with a first aspect of the present invention, a problem with the current state of the art is addressed by a multifunction carrier for accommodating circuit components of a battery system for an electric vehicle, the multifunction carrier comprising: a bus bar assembly having at least a charging terminal bar and a drive terminal bar; and an insulating housing in which the bus bar assembly is embedded, wherein the insulating housing has openings exposing contact surfaces of the terminal bars, and wherein the insulating housing has connectors configured to make pluggable mechanical and electrical contact of the circuit components of the battery system with the opened contact surfaces of the terminal bars.

A technical advantage of such a multi-functional carrier is that it can accommodate a large number of components, such as HV busbars of a busbar system, control and HV taps, PCB connectors, wiring harnesses and electrical components. With such a multi-function carrier, all electrical components can be integrated in one component. Integration of the wiring harness in this component is possible without an additional carrier. This eliminates manual assembly steps, which leads to a higher degree of automation; in particular, full automation of the assembly work steps is possible. Furthermore, many standard parts, such as screws and nuts, are omitted, so that a safeguarding of screw waste is also not necessary.

According to an exemplary embodiment of the multifunction carrier, the connectors are configured to engage with corresponding detents on the circuit components of the battery system when the circuit components of the battery system are inserted into the connectors.

This achieves the technical advantage that the connectors ensure secure electrical and mechanical contacting of the circuit components with the multifunction carrier due to their engagement in the corresponding louvres of the circuit components. The mating can take place in a fully automated manner.

According to an exemplary embodiment of the multifunctional carrier, the insulating housing with the connectors is formed as a one-piece plastic part, in particular as an injection-molded part.

This has the technical advantage that the multifunction carrier is easy to manufacture, e.g., by means of injection molding.

According to an exemplary embodiment of the multifunction carrier, the connectors are formed on an upper surface of the multifunction carrier.

This provides the technical advantage that a tool, such as a robotic arm, can easily access the connectors to attach the circuit components to them.

According to an exemplary embodiment of the multifunction carrier, an underside of the multifunction carrier is provided for cooling the circuit components.

This achieves the technical advantage that efficient cooling of the circuit components is provided. The cooling can, for example, take place via a cooling liquid which is guided along the underside of the multifunction carrier or via a thermally conductive plastic which can also be attached to the underside.

According to an exemplary embodiment of the multifunctional carrier, the connecting rails of the busbar composite run in different planes and a transition between the planes is made by bending the connecting rails.

This has the technical advantage of allowing efficient spatial connection, namely by simply bending the connection rails to bring them out of one plane into the room.

According to an exemplary embodiment of the multifunctional carrier, the open contact surfaces of the terminal rails are formed in the different planes of the busbar composite.

This achieves the technical advantage that various connection options are possible with it. The connections of the multifunctional carrier are therefore not limited to a 2-dimensional carrier in the form of a plate but can be routed 3-dimensionally in space.

According to a another aspect of the present invention, a problem in the current state of the art is solved by a high-voltage contactor for a battery system of an electric vehicle, the high-voltage contactor comprising: a first high voltage terminal; a second high voltage terminal; an electrical switching element for turning on and off an electrical connection between the first high voltage terminal and the second high voltage terminal; an insulating housing comprising the electrical switching element and having openings for the two high voltage terminals; and an interface having a first pin for tapping voltage at the first high voltage terminal, a second pin for tapping voltage at the second high voltage terminal, a third pin for driving the electrical switching element, and a fourth pin for driving the electrical switching element.

This achieves the technical advantage that the manufacturing process of the HV contactor can be fully automated, which leads to significant cost savings in production. The HV contactor is more cost-efficient in production, as complex screwing processes are no longer necessary, and only plugging is required. The switching state of each contactor, e.g., main contactors, DC charging contactors, etc., can always be reliably detected due to the interface for plug-in tapping of the electrical signal. Furthermore, the absence of voltage in the system can be efficiently detected directly at the interface.

The voltage taps on the first high-voltage terminal (HV+ terminal) and on the second high-voltage terminal (HV terminal) can be used to measure whether, for example, there is a voltage difference, i.e., no current is flowing, and the contactor is therefore open. Or it can also be measured whether the system is voltage-free. The contactor coil can be controlled via the third and fourth pins.

By means of this interface, both the coil connections can be controlled and the measurement of the voltage difference at the HV terminals or the HV sense contacting can be carried out.

According to an exemplary embodiment of the high-voltage contactor, the first high-voltage terminal is pluggable to a first terminal rail of a multifunction carrier for receiving circuit components of the battery system of the electric vehicle, in particular a multifunction carrier according to a first aspect of the invention described above; and the second high-voltage terminal is pluggable to a second terminal rail of the multifunction carrier.

This achieves the technical advantage that the HV contactor can be manufactured easily and cost-effectively, as it can be connected to the other components of the system by a simple plug-in process. For example, a robot or another automated process can plug the HV contactor to the connection rails of the multifunction carrier in a fully automated manner.

According to an exemplary embodiment of the high-voltage contactor, the high-voltage contactor has at least two latches which are designed to engage in corresponding connectors of the multifunction carrier when the high-voltage contactor is plugged in, in order to establish a pluggable mechanical and electrical connection of the two high-voltage terminals to corresponding terminal rails of the multifunction carrier.

This achieves the technical advantage that the two detents ensure secure electrical and mechanical contact between the HV contactor and the multifunction carrier. The mating can be carried out in a fully automated manner.

According to an exemplary embodiment of the high-voltage contactor, the interface has two plug-in tongues for tapping voltage at the two high-voltage terminals and two further plug-in tongues for driving the electrical switching element.

This has the technical advantage that the HV signal of the two HV terminals can be easily tapped via the two plug-in tongues and the control signal for the HV contactor can be easily applied via the two further plug-in tongues. Corresponding plugs can be easily connected to the four plug-in tongues.

According to an exemplary embodiment of the high-voltage contactor, the plug-in tongues are formed on a housing side of the high-voltage contactor facing away from the multifunction carrier.

This achieves the technical advantage that the plug-in tongues are easily accessible. A robot arm can, for example, access the multifunction carrier from above in order to contact the two plug-in tongues. As an alternative to plugging/contacting the flat plug-in tongues for the voltage taps, alternative connection options can also be used, such as wire bonding.

According to an exemplary embodiment of the high-voltage contactor, the four pins of the interface are arranged in a connector.

Thus, a technical advantage is achieved in that the HV signal can be easily tapped via the connector and the control signals of the HV contactor can be easily applied. Furthermore, due to its large number of pins, the plug allows not only for a single electrical signal, but several such signals to be tapped or applied, which indicate or control various states of the HV contactor. The connector can be designed for potential isolation so that clearances and creepage distances or insulation are maintained in accordance with the specification.

According to an exemplary embodiment of the high-voltage contactor, the connector is formed on a lateral housing surface of the high-voltage contactor, which extends in a vertical direction to the multifunction carrier.

This has the technical advantage that the connector can be easily picked up, e.g., by a robot arm that accesses the multifunction carrier from above.

The outlet direction of the plug can be led out upwards, i.e., in the direction of the upper side of the multifunction carrier.

According to an exemplary embodiment of the HV contactor, the third pin and the fourth pin provide a coil connection of the electrical switching element for HV contactor actuation.

This has the technical advantage that the HV contactor can be easily controlled via these two additional pins.

According to a third aspect of the invention, a problem with the current state of the art is solved by a method of manufacturing a multifunctional carrier for accommodating circuit components of a battery system for an electric vehicle, the method comprising the steps of: providing a bus bar assembly having at least a charging terminal bar and a drive terminal bar; embedding the bus bar assembly in an insulating housing, wherein the insulating housing has openings exposing contact surfaces of the terminal bars, and wherein the insulating housing has connectors configured to make pluggable mechanical and electrical contact of the circuit components of the battery system with the opened contact surfaces of the terminal bars.

This has the technical advantage that the manufacturing process of the multifunctional carrier can be fully automated, which leads to significant cost savings in manufacturing.

According to a fourth aspect of the present invention, a problem with the current state of the art is solved by a method of manufacturing a high-voltage contactor for a battery system of an electric vehicle, the method comprising the steps of: providing a first high voltage terminal and a second high voltage terminal for the high voltage contactor; providing an electrical switching element for turning on and off an electrical connection between the first high voltage terminal and the second high voltage terminal; embedding the electrical switching element in an insulating housing having openings for the two high voltage terminals; and providing an interface having a first pin for tapping voltage at the first high voltage terminal, a second pin for tapping voltage at the second high voltage terminal, a third pin for driving the electrical switching element, and a fourth pin for driving the electrical switching element.

This has the technical advantage that the manufacturing process of the HV contactor can be fully automated, resulting in significant cost savings in manufacturing.

### BRIEF DESCRIPTION OF THE SEVERAL VIEWS OF THE DRAWINGS

Further advantages features and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

The present invention is described in more detail below with reference to examples of embodiments and the figures, wherein:

FIG. 1 depicts a 3D view of a multi-function carrier 100 in an embodiment without a connector for contactor accommodation according to the disclosure;

FIG. 2 depicts a 3D view of a multi-function carrier 200 in one embodiment with connector for contactor mounting according to the disclosure;

FIG. 3 depicts a 3D view of a multifunction carrier 300 in an embodiment with an integrated contactor according to the disclosure;

FIG. 4 depicts a 3D view of a high voltage contactor 400 according to a first embodiment; and

FIG. 5 depicts a 3D view of a high-voltage contactor 500 according to a second embodiment.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” hould be understood as including only one of A, only one of B, only one of C, or any combination of A, B, and C.

The figures are merely schematic representations and serve only to explain the invention. Identical or similarly acting elements are provided throughout with the same reference signs

In the following detailed description, reference is made to the accompanying drawings, which form a part hereof and in which are shown, by way of illustration, specific embodiments in which the invention may be carried out. It will be understood that other embodiments may be used, and structural or logical changes may be made without departing from the concept of the present invention. Therefore, the following detailed description is not to be understood in a limiting sense. It is further understood that the features of the various embodiments described herein may be combined, unless otherwise specifically indicated.

Aspects and embodiments are described with reference to the drawings, where like reference signs generally refer to like elements. In the following description, for purposes of explanation, numerous specific details are set forth to provide a thorough understanding of one or more aspects of the present invention. However, it may be apparent to one skilled in the art that one or more aspects or embodiments may be embodied with a lesser degree of specific detail. In other instances, known structures and elements are shown in schematic form to facilitate description of one or more aspects or embodiments. It will be understood that other embodiments may be used, and structural or logical changes may be made without departing from the concept of the present invention.

In the following description, reference is made to high-voltage contactors, in particular HV contactors for a battery system of an electric vehicle.

The high-voltage electrical system in electrically powered vehicles operates at DC voltages between 400 V and 800 V, which are life-threatening for humans. To ensure the necessary safety, the high-voltage (HV) part and the 12 V on-board network (LV) are completely insulated from each other. A major challenge for the safety of electric vehicles is the timely detection of insulation faults between the different potentials and, if necessary, the disconnection of the affected circuits. The minimum insulation resistance of the vehicle electrical system must be guaranteed over the entire service life and under all operating conditions. Special high-voltage (HV) contactors provide safe isolation and, in conjunction with a fuse, provide the necessary protection against electric shock.

The contactor is an electrically or electromagnetically operated switch for high electrical power (in the high-voltage range) and is similar to a relay. The contactor knows two switching positions and normally switches monostable without special precautions. If a control current flows through the solenoid coil of an electromechanical contactor, the magnetic field pulls the mechanical contacts into the active state. Without current, a spring restores the rest state and all contacts return to their initial position. The connections for control current for the solenoid coil as well as the contacts for auxiliary circuits (if any) and currents to be switched are isolated from each other in the contactor. There is no conductive connection between control and switching contacts. This makes the contactor a relay with a much higher switching capacity, suitable for the high-voltage range. Typical loads start at around 500 watts up to several hundred kilowatts.

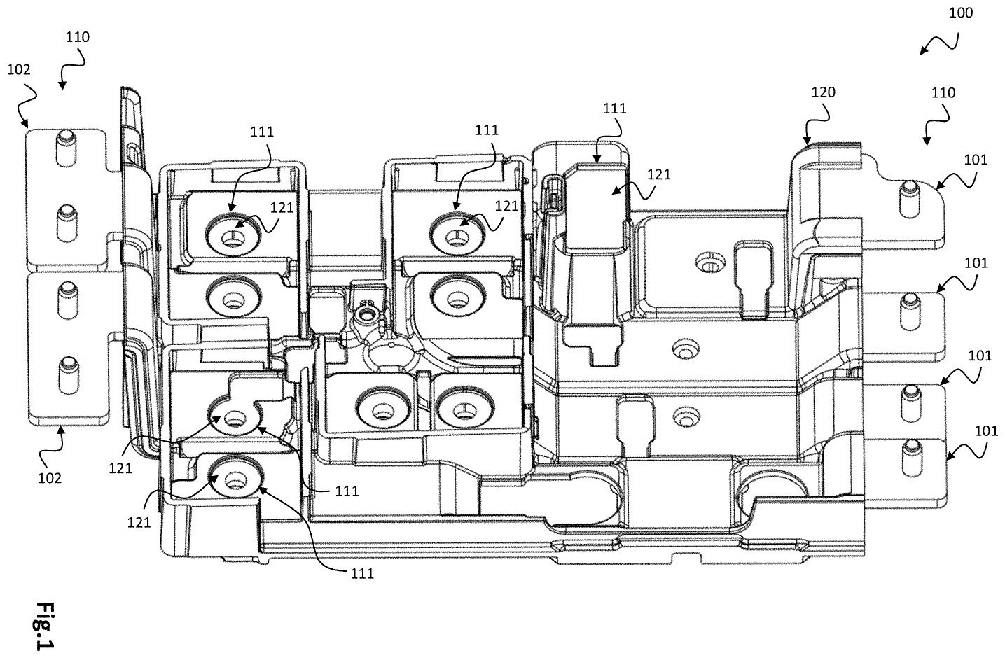

FIG. 1 depicts a 3D view of a multifunction carrier 100 in an embodiment without connectors for contactor accommodation according to the disclosure.

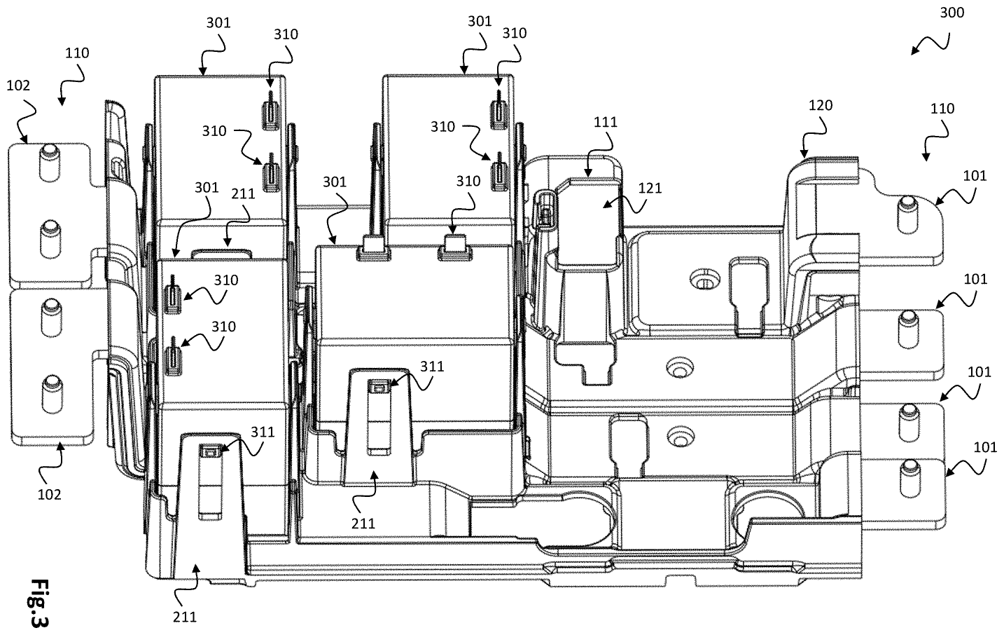

The multi-function carrier 100 is used to hold circuit components of a battery system for an electric vehicle, for example a high voltage contactor 301, 400, 500 as shown in FIGS. 3, 4 and 5. Further, it can be used to hold other circuit components, such as a set of leads, board connectors, as well as other electrical components. The multi-function carrier 100 includes a bus bar assembly 110 having at least a charging terminal bar 101 and a drive terminal bar 102; and an insulating housing 120 in which the bus bar assembly 110 is embedded.

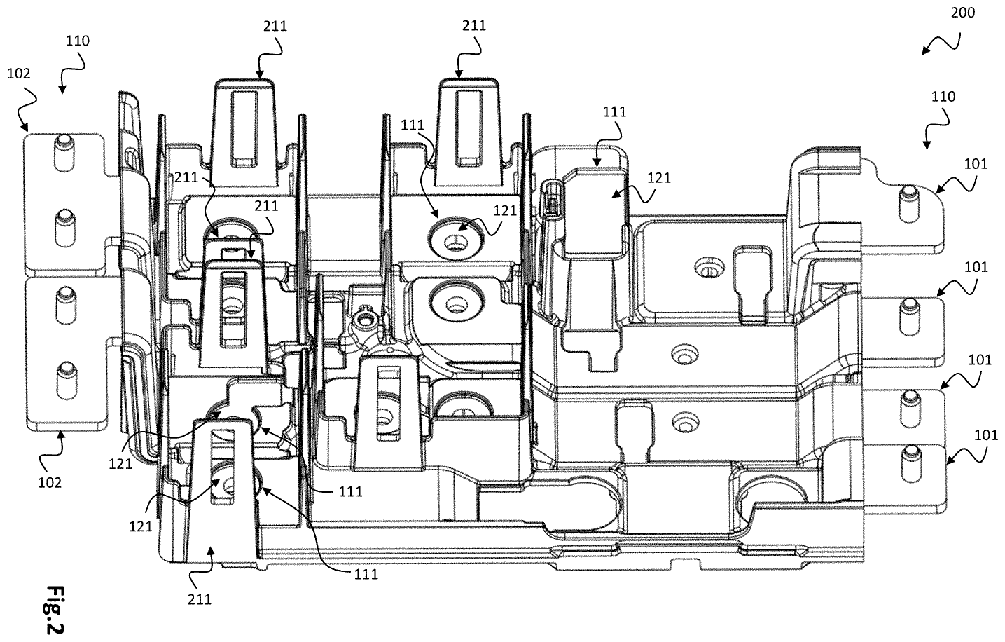

The insulating housing 120 has openings 111 exposing contact surfaces 121 of the terminal rails 101, 102. Further, the insulating housing 120 comprises connectors, e.g. connectors 211, as shown in more detail in FIG. 2, which are adapted to establish pluggable mechanical and electrical contact between the circuit components 301, 400, 500 of the battery system and the opened contact surfaces 121 of the terminal rails 101, 102.

The multifunction carrier 100 provides an appropriate electrical connection of the charging terminal rails 101 with the drive terminal rails 102 via the circuit components. For example, one or more such HV contactors may switch on and off an electrical connection between a charging terminal rail 101 and a drive terminal rail 102, thereby providing for switching on the drive by connecting to the battery or for switching off the drive by disconnecting from the battery.

The connection rails 101, 102 may each include a positive path and a negative path. The positive path may be at HV potential, for example 400 to 800 V, while the negative path may be at ground.

An underside of the multifunction carrier 100 (extending into the drawing plane) may be provided for cooling the circuit components. For example, a thermally conductive plastic may be provided on the underside to dissipate heat from the circuit components. Alternatively or additionally, a cooling system comprising cooling fluid may be provided across the underside to also dissipate heat from the circuit components.

The connecting rails 101, 102 of the busbar system 110 can run in different planes, as can be seen in the 3D representation of FIG. 1. Thereby, a transition between the planes can be made by bending the connecting rails 101, 102. Such a bending can easily be realized by bending tools.

The open contact areas 121 of the terminal rails 101, 102 may be respectively formed in the different planes of the busbar assembly 110 to provide a plurality of connection options.

In the illustration of FIG. 1, four charging connector rails 101 and four drive connector rails 102 are shown. However, other combinations of connector rails may be implemented, for example two loading connector rails 101 and two drive connector rails 102, or two loading connector rails 101 and four drive connector rails 102, or four loading connector rails 101 and two drive connector rails 102, or any other combination. The connection rails may be subdivided in their course from the left of the drawing to the right of the drawing, forming sub-connection rails which may be interconnected by appropriate circuit components. Any number of contact openings may be formed in the terminal rails to provide corresponding electrical connections.

FIG. 2 shows a 3D view of a multi-function carrier 200 in one embodiment with connector for contactor accommodation according to the disclosure.

The multi-function carrier 200 corresponds to the multi-function carrier 100 described in FIG. 1 but is shown here in FIG. 2 together with the connectors for contactor mounting.

The multi-function carrier 200 is for housing circuit components of a battery system for an electric vehicle, as described above with respect to FIG. 1. The multifunction carrier 200 includes a bus bar assembly 110 having at least a charge terminal bar 101 and a drive terminal bar 102; and an insulating housing 120 in which the bus bar assembly 110 is embedded.

The insulating housing 120 has openings 111 exposing contact surfaces 121 of the terminal rails 101, 102. Further, the insulating housing 120 comprises connectors 211. The connectors 211 are configured to make pluggable mechanical and electrical contact between the circuit components 301, 400, 500 of the battery system and the opened contact surfaces 121 of the terminal rails 101, 102.

The connectors 211 are configured to engage corresponding detents 311 on the circuit components 301, 400, 500 of the battery system as they are plugged into the connectors 211, as shown in FIGS. 3, 4 and 5.

The connectors 211 may be elongated in shape and extend in a trapezoidal shape vertically away from the base side of the multi-function carrier, with the longer side of the trapezoid formed on the base side. The connectors 211 may have a slot in the center into which the corresponding latches 311 of the circuit components 301, 400, 500 can be inserted or engaged.

The insulating housing 120 may be formed together with the connectors 211 as a one-piece plastic part, such as an injection molded part.

The connectors 211 may be formed on an upper surface of the multifunction carrier 200, as shown in FIG. 2. The connectors 211 may be formed in different planes of the multifunction carrier 200, for example according to the bending path of the connecting rails 101, 102.

FIG. 3 shows a 3D view of a multifunction carrier 300 in an embodiment with an integrated contactor according to the disclosure.

The multifunction carrier 300 corresponds to the multifunction carriers 100, 200 described for FIGS. 1 and 2, but is shown here in FIG. 3 with integrated contactor components 301, i.e., with contactor components 301 plugged into the connectors 211.

The multi-function carrier 300 is for housing circuit components of a battery system for an electric vehicle, as described above with respect to FIG. 1 and FIG. 2. The multifunction carrier 300 includes a bus bar assembly 110 having at least a charge terminal bar 101 and a drive terminal bar 102; and an insulating housing 120 in which the bus bar assembly 110 is embedded.

The insulating housing 120 has openings 111 exposing contact surfaces 121 of the terminal rails 101, 102. Further, the insulating housing 120 comprises connectors 211. The connectors 211 are configured to make pluggable mechanical and electrical contact between the circuit components 301, 400, 500 of the battery system and the opened contact surfaces 121 of the terminal rails 101, 102.

The connectors 211 are configured to engage with corresponding detents 311 on the circuit components 301 when the circuit components 301 are inserted into the connectors 211.

The insulating housing 120 may be formed together with the connectors 211 as a one-piece plastic part, such as an injection molded part.

The connectors 211 may be formed on an upper surface of the multifunction carrier 300. The connectors 211 may be formed in different planes of the multifunction carrier 300, for example according to the bending path of the connecting rails 101, 102.

An underside of the multifunction carrier 300 (extending into the drawing plane) may be provided for cooling the circuit components, as described above.

The connecting rails 101, 102 of the busbar system 110 can run in different planes, as can be seen in the 3D representation of FIG. 3. In this case, a transition between the planes can be made by bending the connecting rails 101, 102. Such a bending can easily be realized by bending tools.

The opened contact areas 121 of the terminal rails 101, 102 may be respectively formed in the different planes of the busbar assembly 110 to provide a plurality of connection options.

FIG. 3 thus illustrates a possible arrangement of a multi-function carrier 300 which can accommodate HV busbars 101, 102 (busbar assembly 110—may also control and HV taps), board connectors, wiring harness and electrical components. This can be fed fully automatically, can be welded at HV interfaces and allows machine inspection of secondary interlocks. Air and creepage distances can also be considered here due to the insulation with smaller dimensions. With a thermally conductive plastic, hot spots in the system can also be connected, e.g., to a cooling system.

Fabrication of multifunction carrier 300 may include the following fabrication steps: injection molding bus bars 101, 102, clipping HV-E components 301, wire routing or overmolding a bus bar composite 110, overmolding HV/LV wire set to directly mate LTGS (wire set), injection mating connectors to directly contact electronics. All HV-STS (high voltage busbar) assemblies 110 can be welded.

This allows the following advantages to be achieved: integration of all electrical components in one component; integration of wiring harness in this component without additional support; manual assembly steps are eliminated, fully automated production is possible; and elimination of many standard parts (e.g. screws/nuts), so that there is no need to secure screw waste.

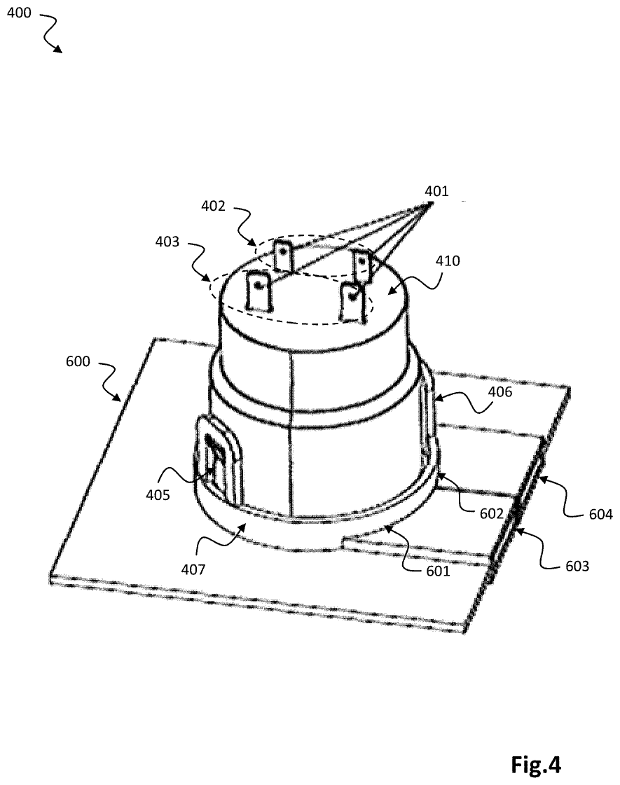

FIG. 4 depicts a 3D view of a high-voltage contactor 400 according to a first embodiment of the present invention.

The high voltage contactor 400 is for a battery system of an electric vehicle. The high voltage contactor 400 includes a first high voltage terminal 601; a second high voltage terminal 602; an electrical switching element for turning on and off an electrical connection between the first high voltage terminal 601 and the second high voltage terminal 602; an insulating housing 407 including the electrical switching element and having openings for the two high voltage terminals 601, 602; and an interface 401 having a first pin for tapping voltage at the first high voltage terminal 601, a second pin for tapping voltage at the second high voltage terminal 602, a third pin for driving the electrical switching element, and a fourth pin for driving the electrical switching element.

The first high-voltage terminal 601 is pluggable to a first connector rail 603 of a multifunction carrier 600 for receiving circuit components of the battery system of the electric vehicle. The multifunction carrier 600 may be a multifunction carrier 100, 200, 300 as described above with respect to FIGS. 1 to 3. The second high voltage terminal 602 is pluggable to a second connector rail 604 of the multifunction carrier 600. The connector rails 603, 604 may be, for example, a charging connector rail 101 and a drive connector rail 102, as described above with respect to FIGS. 1 and 2.

The high-voltage contactor 400 has at least two latches 405, 406 which are configured to engage when the high-voltage contactor 400 is plugged into corresponding connectors 211 of the multifunction carrier 100, 200, 300, 600, as. shown, for example, with respect to FIGS. 2 and 3, in order to establish a pluggable mechanical and electrical connection of the two high-voltage terminals 601, 602 with corresponding terminal rails 603, 604, 101, 102 of the multifunction carrier 600.

The interface 401 may comprise two plug-in tongues 402 for plug-in voltage tapping at the two high-voltage terminals 601, 602 and two further plug-in tongues 403 for driving the electrical switching element. Instead of the two pairs of plug-in tongues 402, 403, several pairs of plug-in tongues 402, 403 may also be implemented, for example in order to tap off further voltages or to control signals.

The two pairs of mating tabs 402, 403 may be formed on a housing side 410 of the high voltage contactor 400 facing away from the multifunction carrier 600.

The HV contactor may be cylindrical or conical or cuboidal in shape, each with appropriate gradations. A stepped cone shape is shown in FIG. 4, and a cuboid shape is shown for the HV contactor 301 in FIG. 3.

In the embodiment of FIG. 4, the two tabs 403 may provide the coil connection and the two tabs 402 may provide the tap for the HV signal or HV sense.

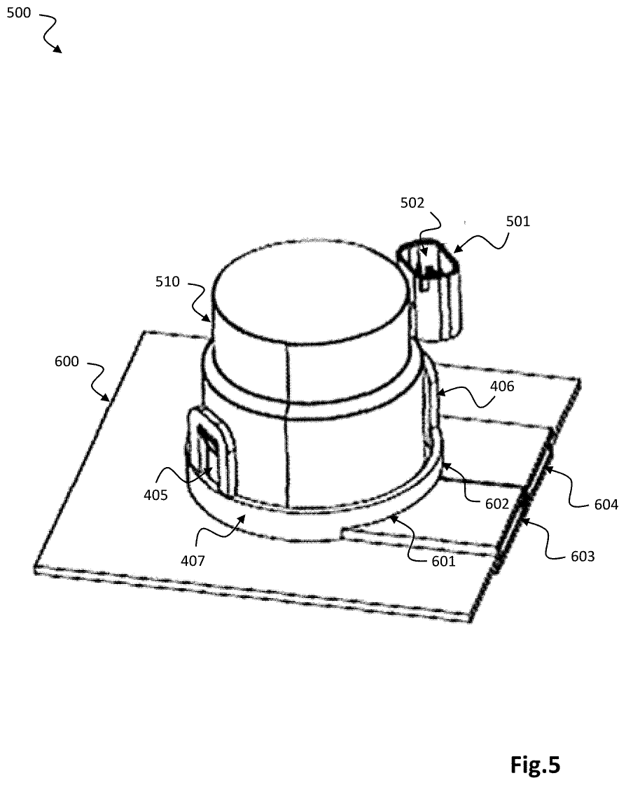

FIG. 5 depicts a 3D view of a high-voltage contactor 500 according to a second embodiment of the present invention.

The high voltage contactor 500 may be similar in construction to the high voltage contactor 400 described above with respect to FIG. 4.

The high voltage contactor 500 comprises a first high voltage terminal 601; a second high voltage terminal 602; an electrical switching element for turning on and off an electrical connection between the first high voltage terminal 601 and the second high voltage terminal 602; an insulating housing 407 comprising the electrical switching element and having openings for the two high voltage terminals 601, 602; and an interface 501 having a first pin for tapping voltage at the first high voltage terminal 601, a second pin for tapping voltage at the second high voltage terminal 602, a third pin for driving the electrical switching element, and a fourth pin for driving the electrical switching element.

The first high-voltage terminal 601 is pluggable to a first connector rail 603 of a multifunction carrier 600 for receiving circuit components of the battery system of the electric vehicle. The multifunction carrier 600 may be a multifunction carrier 100, 200, 300 as described above with respect to FIGS. 1 to 3. The second high voltage terminal 602 is pluggable to a second connection rail 604 of the multifunction carrier 600. The connector rails 603, 604 may be, for example, a charging connector rail 101 and a drive connector rail 102, as described above with respect to FIGS. 1 and 2.

The high-voltage contactor 500 has at least two latches 405, 406 which are configured to engage when the high-voltage contactor 500 is plugged into corresponding connectors 211 of the multifunction carrier 100, 200, 300, 600, as shown, for example, with respect to FIGS. 2 and 3, in order to establish a pluggable mechanical and electrical connection of the two high-voltage terminals 601, 602 with corresponding terminal rails 603, 604, 101, 102 of the multifunction carrier 600.

The interface 501 has a connector in which the four pins 502 of the interface 501 are arranged. The connector may be a male or female connector. The connector may be designed for potential isolation, so that clearance and creepage distance or insulation are maintained in accordance with the requirements.

The connector may be formed on a lateral housing surface 510 of the high-voltage contactor 500, which extends in a vertical direction with respect to the multifunction carrier 600, i.e., out of the drawing plane of FIG. 5.

Alternatively, the interface 501 may be aligned with the side of the contactor at which the HV terminals 601, 602 are located.

The HV contactors as described and depicted in FIGS. 3 to 5 offer the possibility of tapping the HV potentials of the two HV terminals 601, 602 by means of a plug-in system 501, 502 or flat plug tongues 402 integrated on the contactor 400, 500. In this way, additionally attached ring cable lugs or flat connectors can be omitted.

Such a HV contactor 301, 400, 500 is less expensive to produce, e.g., by eliminating the screwing process, with only plugging required instead. The switching state of each contactor (e.g., main contactors, DC charging contactors) can always be reliably detected. Furthermore, the absence of voltage in the system (as previously with the ring cable lugs in the HV wiring harness) can be easily determined.

Having described some aspects of the present disclosure in detail, it will be apparent that further modifications and variations are possible without departing from the scope of the disclosure. All matter contained in the above description and shown in the accompanying drawings shall be interpreted as illustrative and not in a limiting sense.

1. A multifunction carrier for holding circuit components of a battery system for an electric vehicle, the multifunction carrier comprising:
a busbar assembly comprising at least a charging terminal bar and a drive terminal bar; and
an insulating housing configured to accommodate in which the busbar assembly embedded therein,
wherein the insulating housing comprises openings exposing contact surfaces of the terminal rails, and
wherein the insulating housing comprises connectors configured to make pluggable mechanical and electrical contact between the circuit components of the battery system and the open contact surfaces of the terminal rails.

2. The multifunction carrier according to claim 1,
wherein the connectors are configured to engage in corresponding latches arranged on the circuit components when the circuit components of the battery system are plugged into the connectors.

3. The multifunction carrier according to claim 1,
wherein the insulating housing with the connectors is formed as a at least one of a one-piece plastic part and an injection-molded part.

4. The multifunction carrier according to claim 1,
wherein the connectors are arranged on an upper surface of the multifunction carrier.

5. The multifunction carrier according to claim 1,
wherein an underside of the multifunction carrier is configured for cooling the circuit components.

6. The multifunction carrier according to claim 1,
wherein the connecting rails of the conductor rail system are arranged to extend in different planes and a transition between the planes comprises bends in the connecting rails.

7. The multifunction carrier according to claim 6,
wherein the open contact surfaces of the connecting rails are arranged in different planes of the busbar composite.

8. A high voltage contactor for a battery system of an electric vehicle, the high voltage contactor comprising:
a first high-voltage terminal;
a second high-voltage terminal;
an electrical switching element configured for switching on and off an electrical connection between the first high-voltage terminal and the second high-voltage terminal;
an insulating housing comprising the electrical switching element and openings for the two high-voltage terminals; and
an interface comprising:
a first pin configured for voltage tapping at the first high-voltage terminal,
a second pin configured for voltage tapping at the second high-voltage terminal,
a third pin configured for driving the electrical switching element, and
a fourth pin configured for driving the electrical switching element.

9. The high voltage contactor according to claim 8,
wherein the first high-voltage terminal is configured to be pluggable to a first connection rail of a multifunctional carrier configured for receiving at least one of circuit components of the battery system of the electric vehicle and a multifunctional carrier for holding circuit components of a battery system for an electric vehicle, the multifunction carrier comprising a busbar assembly comprising at least a charging terminal bar and a drive terminal bar, and an insulating housing configured to accommodate the busbar assembly embedded therein, wherein the insulating housing comprises openings exposing contact surfaces of the terminal rails, and wherein the insulating housing comprises connectors configured to make pluggable mechanical and electrical contact between the circuit components of the battery system and the open contact surfaces of the terminal rails; and
wherein the second high-voltage terminal is configured to be plugged onto a second connection rail of the multifunction carrier.

10. The high voltage contactor according to claim 9, comprising:
at least two catches configured to engage when the high-voltage contactor is plugged into corresponding connectors of the multifunction carrier, in order to produce a pluggable mechanical and electrical connection of the two high-voltage terminals to corresponding connecting rails of the multifunction carrier.

11. The high voltage contactor according to claim 9,
wherein the interface comprises two plug-in tongues configured for plug-in voltage tapping at the two high-voltage terminals and two further plug-in tongues configured for driving the electrical switching element.

12. The high voltage contactor according to claim 11,
wherein the plug-in tongues are arranged on a housing side of the high-voltage contactor facing away from the multifunction carrier.

13. The high voltage contactor according to claim 9,
wherein the four pins of the interface are arranged in a connector.

14. The high voltage contactor according to claim 13,
wherein the connector is arranged on a lateral housing surface of the high-voltage contactor which extends in a vertical direction to the multifunction carrier.

15. The high voltage contactor according to claim 8,
wherein the third pin and the fourth pin provide a coil connection of the electrical switching element for HV contactor control.
